(19) United States
(12) Patent Application Publication
(10) Pub. No.: US 2025/0383636 A1
(43) Pub. Date: Dec. 18, 2025

(54) CLASSIFICATION OF TICKETS IN BUILDING AUTOMATION USING A LARGE LANGUAGE MODEL

(71) Applicant: Siemens Schweiz AG, Zurich (CH)

(72) Inventors: Rakebul Hasan, Landshut (DE); Qinpeng Wang, Orlando, FL (US); Serghei Mogoreanu, Munich (DE); Marcel Hildebrandt, Munich (DE); Mark Buckley, Munich (DE)

(73) Assignee: Siemens Schweiz AG, Zurich (CH)

(21) Appl. No.: 18/742,739

(22) Filed: Jun. 13, 2024

(51) Int. Cl. G05B 13/02

(52) U.S. Cl. CPC G05B 13/027

(57) ABSTRACT

For ticket classification in a building automation system, a large language model (LLM) is used to classify. In one approach, a prompt is generated for zero-shot classification, and a prompt is generated for few-shot classification. In another approach, a hybrid annotation provides corrections (review) by an expert to correct LLM classification for sample tickets to be used as examples in the few-shot classification. The LLM may operate on a diverse and complex range of tickets in an efficient and scalable manner.

### BACKGROUND

The present embodiments relate to building automation. In the building automation domain, engineers for the building automation system routinely report a diverse and complex range of issues to a manufacturer or service. Each of these issues, whether related to hardware malfunctions, software and configuration anomalies, or design and efficiency concerns, requires a unique and specialised set of actions for resolution. The sheer variety and complexity of these issues make it a challenging task to efficiently classify and prioritise the report tickets, ensuring that the report tickets are directed to the appropriate technical teams or departments for timely resolution. The diversity and complexity of issues require a classification system that can accurately understand and classify the report based on nuances and technical details.

Given the possibly large number of tickets generated, especially in sizable or multi-site building automation setups, it is crucial for the classification system to operate swiftly and scale according to demand, ensuring that no ticket is left unaddressed or misclassified. Addressing these problems is of paramount importance not just for operational efficiency, but also to enhance customer satisfaction. When issues are rapidly and accurately classified, they can be resolved more efficiently, leading to reduced downtimes and better user experiences.

Manual classification is time consuming and subject to user error. The classification of customer tickets has been approached using traditional supervised machine learning techniques. This approach requires a large set of labelled samples, which poses two primary challenges. First, the manual annotation of this data is labour-intensive. Second, if one attempts to circumvent this by using heuristic-based automatic labelling, the generated training data can lack diversity and lead to classifiers with reduced accuracy.

### SUMMARY

Systems, methods, and non-transitory computer readable storage media storing instructions (program code) are provided for ticket classification in a building automation system. A large language model (LLM) is used to classify. In one approach, a prompt is generated for zero-shot classification, and another prompt is generated for few-shot classification. In another approach, a hybrid annotation provides corrections (review) by an expert to correct LLM classification for sample tickets to be used as examples in the few-shot classification. The LLM may operate on a diverse and complex range of tickets in an efficient and scalable manner.

In a first aspect, a method is provided for ticket classification in a building automation system. A building automation ticket for an issue in the building automation system is received. A prompt including the building automation ticket is generated. The prompt includes a request for classification of the building automation ticket. The LLM classifies the building automation ticket in response to input of the prompt to the LLM. The building automation ticket is transferred based on the classification.

In a second aspect, a method is provided for ticket classification in a building automation system. An LLM performs zero-shot classification for each of a first set of sample building automation tickets. A user reviews the zero-shot classification. A first building automation ticket for the building automation system is received. The LLM performs a few-shot classification for the first building automation ticket. The few-shot classification uses information selected from a second set of sample building automation tickets. The second set includes at least some of the sample building automation tickets of the first set and the zero-shot classifications from the first set after the reviewing. The building automation ticket is transferred based on the classification.

In a third aspect, a building automation ticket classification system includes: a first interface configured to receive a first building automation ticket comprising a title and description of an issue in a building automation component; a processor configured to generate a prompt, the prompt including the first building automation ticket, a similar sample building automation ticket with a sample class based on a zero-shot classification by a large language model of the similar sample building automation ticket; a second interface configured to receive a first class for the first building automation ticket, the first class generated by the large language model in response to input of the prompt; and a memory configured to store the first class.

Any one or more of the aspects or concepts summarized above or in the Illustrative Embodiments below may be used alone or in combination. The aspects or concepts described for one Illustrative Embodiment or aspect may be used in other embodiments or aspects. The aspects or concepts described for a method or system may be used in others of a system, method, or non-transitory computer readable storage medium.

These and other aspects, features, embodiments, and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 is a flow chart diagram of one implementation of a method for ticket classification in a building automation system;

FIG. 2 is a flow chart diagram of another implementation of a method for ticket classification in a building automation system;

FIG. 3 illustrates an example prompt for zero-shot classification;

FIG. 4 illustrates an example prompt for few-shot classification;

FIG. 5 is a block diagram of one embodiment of a building automation ticket classification system; and

FIG. 6 is a block diagram of an example LLM.

### DETAILED DESCRIPTION OF EMBODIMENTS

A generative artificial intelligence (AI)-driven approach is provided for ticket classification. The capabilities of generative LLM, such as GPT-4, are used to approach the classification problem. Various features may be used for LLM classification of a building automation ticket. In zero-shot classification, by merely providing the LLM with definitions of the pre-defined classes, one can inquire with which class a given customer ticket aligns. In a hybrid annotation approach, corrections or reviews are initially made on the LLM's predictions using the zero-shot classification approach. Corrections (e.g., selection by review) may be more efficient than manual annotations. When resources permit, comprehensive annotations can be implemented where an expert picks the most fitting class for a ticket. This manual annotation may be performed minimally. In minimal manual annotation, rather than manually labelling thousands of samples as in traditional supervised approaches, annotation of only a limited number (e.g., 10% of the available samples or a few hundred samples) is used. The corrected (reviewed) and/or manually annotated classifications of sample tickets provide a database for in-context learning or classification. This database of annotated samples may be split. The annotated samples are partitioned, such as about 50% serving as a held-out evaluation dataset, while the rest aid in in-context learning. In an in-context learning or classification (i.e., few-shot classification), a few in-context examples are chosen from the in-context learning dataset based on similarity to the input ticket or other criterion. The number of examples selected is determined by the context size limit of the LLM but is typically fewer than 100 examples.

Any of these approaches may be combined. For example, an LLM, zero-shot classification, few-shot classification, and an annotation tool for classifying customer tickets are used together in the specific domain of building automation for ticket classification. As a further example, the hybrid annotation approach is included in the above example where an annotator corrects (selects another class or selects only samples that have the correct class) the output of the zero-shot classifier instead of manually selecting the correct class. In another example, examples are included in the few-shot classification prompt. The examples are selected from a partition of the annotated labelled data produced by the hybrid annotation approach (and optionally augmented with manually annotated labelled data).

The use of LLM in ticket classification may minimize manual labor. The time and resources for manual ticket annotation are reduced, presenting a more cost-effective solution. The use of current generative LLMs ensures that the system is tapping into the most recent advancements in AI, benefiting from the vast knowledge these models offer, especially in technical domains. The introduction of in-context or few-shot learning means that the system can improve its accuracy and adaptability with a relatively small set of labelled data, further streamlining the process and ensuring better results.

For diversity and complexity, traditional systems use heuristic-based, automatically labelled data for machine learning models. Creating exhaustive heuristics for all case variations is not practical. This results in limited diversity in training data. In contrast, LLMs are trained on extensive data sets. This allows better handling of diverse cases. LLMs are also pre-configured to understand technical domains like building automation. The LLMs require no additional fine-tuning for this. Additionally, some LLMs can manage linguistic diversity. Issues like polysemy, homonymy, and synonym usage are understood. This enables the model to interpret diverse language expressions effectively.

For efficiency and scalability, the system employs zero-shot classification. This allows classification of new problems without prior examples. The system also learns from past tickets where hybrid annotation is used. In-context learning and manual annotations may be used for efficiency and scalability. A large number of manual annotations are not required. Thus, the system is suitable for low-resource settings. These features ensure quick and accurate ticket classification. This leads to faster problem resolution and improved user satisfaction. The LLM provides for better processing utilization than heuristic-based machine learning.

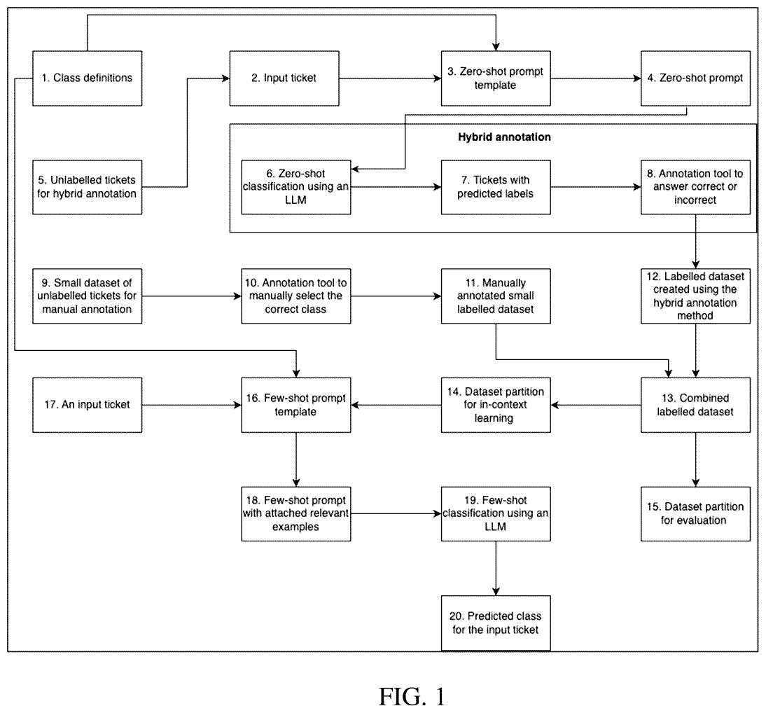

FIG. 1 shows an example implementation of a method for ticket classification in a building automation system. LLM is prompted to classify a building automation ticket (report or help request). LLM alone as calibrated for building automation, alone with zero-shot classification, few-shot classification based on annotated samples (e.g., manual annotation and/or hybrid corrections), split usage of examples, another enhancement, and/or combinations thereof classify a ticket, allowing transfer, queuing, and/or other process for addressing the ticket.

The method is performed in the order shown (e.g., following arrows or numerical), but other orders may be used. For example, acts for manual annotation (e.g., acts 9-11) are performed prior to act 2 and/or 6. As another example, acts 16 and 17 are performed prior to act 2. In one implementation, acts 1-15 are pre-computed or performed prior to use of the LLM for a given input ticket of act 17. Acts 16-20 are then performed as needed when each new input ticket is received in act 17.

Additional, different, or fewer acts may be provided. For example, acts 9-11, associated with manual classification without the LLM for creating examples, are not performed. As another example, (1) acts 2-6 and/or (2) acts 7-8 and 12 are not performed. In another example, acts 1-4 and 6 are performed alone where the input ticket received in act 2 is a ticket from a customer or building engineer rather than a sample (example) ticket received in act 2 from a database of tickets formed in act 5.

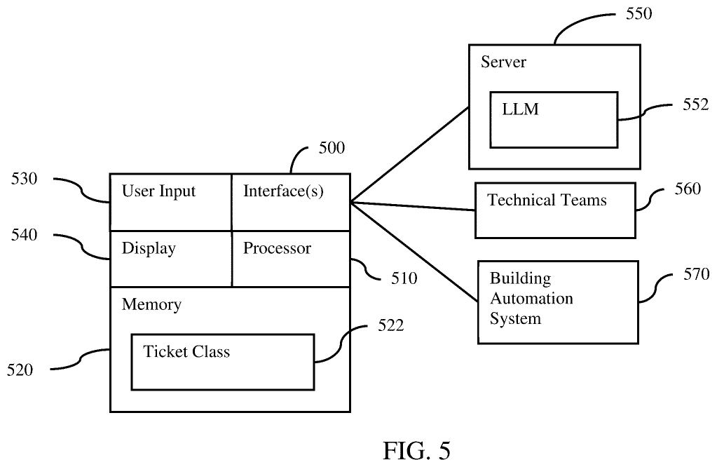

The method is performed by a processor using a memory and interfaces and/or the system of FIG. 5. A memory stores the LLM (AI), input ticket, classes, templates, prompts, sets of sample tickets with or without classes, and/or other information used to classify by the LLM. A processor generates a prompt and/or handles communication of information. The same or a different processor applies the LLM. A user input is provided for user interaction, such as to correct (e.g., review, change, or select) zero-shot classification. The interfaces receive various information and/or communications, and handle transfer for further processing of the ticket based on the classification. A building automation system may have various components with programmable control, which components and/or control are altered based on a solution generated in response to the transfer of the ticket based on the LLM classification. The processor(s) perform various acts to acquire, form, receive, generate, execute, transfer, and/or alter. A display may be used to display results, such as the ticket with a labeled classification. Other devices, circuits, or equipment may be used.

In act 1, a designer defines the classes. An expert in building automation and help tickets for building automation defines the various categories to which help tickets may belong. The classes are defined for a given building automation system or building automation in general. The classes may be defined based on the organization of technicians or groups that may be responsible for addressing help requests. For example, expert groups at the manufacturer may be separated by type of component or component grouping, so the classes correspond to the types of components. In another approach, the classes are based on common issues. The classes may be defined based on a combinations of purposes.

The classes may be defined with a label (class) as well as a natural language definition. The natural language definition may assist the LLM. Other definitions may be used, such as using bullet points, technical manual references or links, and/or ontology information for components of building automation.

In one example implementation, the classes include: (1) Coil/Valve Issue: coil is fouled or clogged, valve is stuck or leaking; (2) Damper Issue: damper is stuck or leaking; (3) Design Issue: coil or fan is undersized or oversized; (4) Duct Issue: duct leakage (rare failure mode, can only be detected if we can rule out all other failure modes that impact system pressurization); (5) Filter Issue: filter is fouled; (6) Point Override: command or setpoint is overridden so always stays constant; (7) Programming Issue: sequence of operation is not properly programmed according to design document; fan is supposed to turn off during unoccupied mode but not programmed that way; (8) Sensor Issue: sensor error, from out of calibration or incorrect installation; (9) Setpoint Issue: unreasonable setpoint by user; (10) Cool/Heat Source Issue: cooling or heating plant (chiller, boiler, pumps) is not operating as expected; (11) Fan Issue: belt failure, VFD failure or on manual override; and (12) Energy/Efficiency Opportunity: suggest adding a reset or economizer sequence to the system; suggest running equipment on a schedule instead of 24-7. Other classes and/or descriptions may be used.

In act 5, an expert or processor identifies or creates a collection of sample tickets. For example, tickets received over a time period for a variety of different building automation systems or for a specific building automation system are collected. These sample tickets are unlabeled. No class is assigned. Tickets with an assigned class may have the class removed for use to create the collection.

The collection of sample tickets is to be used for the hybrid annotation in acts 6-8. Each ticket in this dataset is passed to component 2, which subsequently creates a zero-shot prompt for each ticket.

The ticket has any format. For example, the ticket may be formatted based on structured entry. As another example, the ticket is formatted as an e-mail or other communication. In one implementation, the ticket includes a subject or title and a description. The description is natural language or may be a structured entry created by selection. For natural language, the description may be of any length, such as one to ten sentences and/or clauses. The title and description may be extracted from the ticket communication.

In act 2, a processor selects a ticket from the dataset collected in act 5. Each or a sub-set of the tickets are sequentially selected and/or separately processed in acts 3, 4, and 6-8. An individual ticket is selected in act 2 from the dataset. The selection is repeated.

In act 3, the processor selects a zero-shot prompt template. A standardized template is used for prompting the LLM in act 6. The processor identifies the appropriate template.

The template sets or has fields for the information to be used in the prompt. Any of various types of information may be used. For example, the prompt template includes one or more instructions to the LLM, a field or fields for the classes and descriptions, a field or fields for the ticket, and a question. The instruction and the question relate to the purpose, such as informing the LLM what it will be given as the instruction and asking the class as the question. In another example, the template defines the information to be extracted and used to generate the prompt in act 4. The zero-shot prompt template takes the class definitions from act 1 and an individual ticket from the dataset in act 5 as selected in act 2 for creation of the zero-shot prompt in act 4 for each individual ticket. Other formats for the template may be used.

In act 4, the processor generates the zero-shot prompt. The template is filled. Data mining, searching, look-up, or other process extracts the information to populate the template selected in act 3. By using the template, the information is reformatted as defined by the template. The processor instantiates the zero-shot prompt using the prompt template.

In one example, the ticket includes a subject as “EECC AHU01 Economizer Mode,” and description as “Initiate programming corrections to the economizer mode operation. Economizer mode is not activated at conducive Outside Air Conditions. Verify if the AHU had an economizer mode. If yes, what is the temperature of enthalpy ON/OFF value.” This information is populated into a title and description fields of the template. The classes and descriptions are populated into a class field.

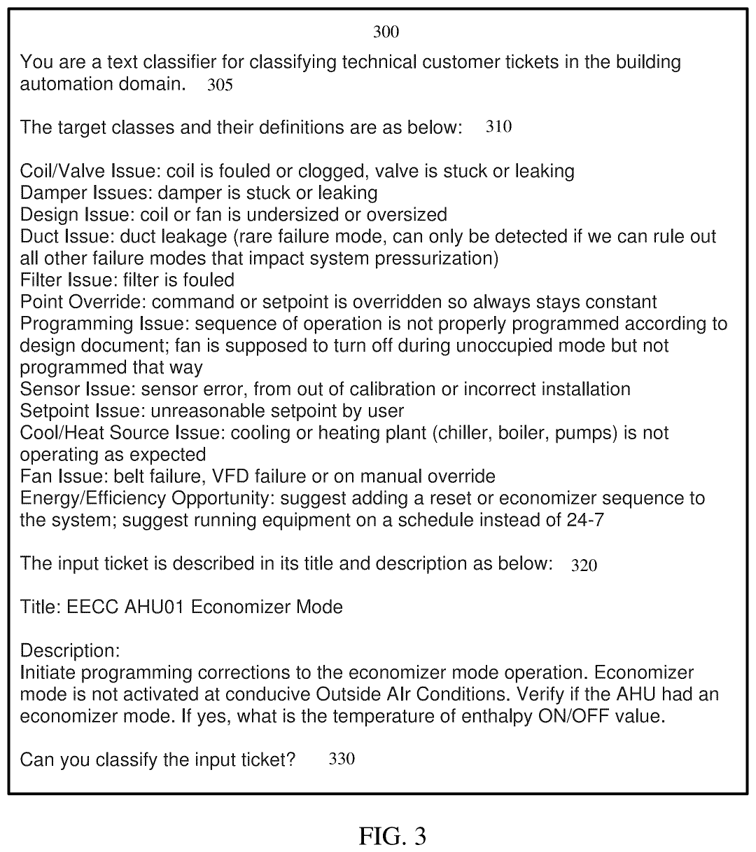

FIG. 3 shows an example zero-shot prompt 300. The zero-shot prompt 300 includes an instruction 305, classes and definitions 310, sample ticket information 320, and a question or prompt 330. Additional, different, or less information may be included.

In act 6, a processor performs zero-shot classification. The processor is the same one performing acts 3 and 4 or a different processor. For example, the prompt is sent to an LLM service or server, which performs act 6 based on the prompt generated in act 4.

The zero-shot classification is performed for each of the sample tickets of the dataset collected in act 5. All the zero-shot prompts generated in act 4 are passed to this classifier (i.e., LLM). Each prompt is sent to the LLM.

Zero-shot classification is classification based on the one ticket. Other sample tickets and/or sample tickets related to class are not provided in the prompt.

The LLM performs the classification in response to input of the prompt. The LLM is any now known or later developed LLM, such as GPT (e.g., GPT-4) by OPENAI, PALM or GEMINI by GOOGLE, XAI by GROK, LLAMA (e.g., LLAMA-3) by META, CLAUDE by ANTHROPIC, DBRX by DATABRICK, or another LLM. In one implementation, the LLM is one exposed or trained on technical data. The technical data may or may not be specific to building automation. For example, GPT-4 was trained on a corpus that includes technical documents.

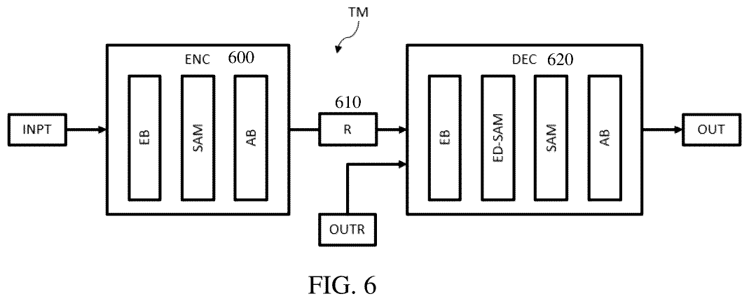

In one approach, the LLM is a transformer formed by a set of neural networks that consist of an encoder and a decoder with self-attention capabilities. In another approach, the LLM is an architecture with transformer decoder-only. As another approach, the LLM uses a recurrent neural network and/or a state space model. The LLM acquires knowledge about syntax, semantics, and ontology in human language corpora through machine learning. LLMs harness language datasets to generate human-like text. When integrated with chain-of-thought prompting, these models connect disparate pieces of information coherently, forming a logical narrative. FIG. 6, described below, shows an example neural network forming an LLM.

In one approach, the LLM is used to answer the prompt without further calibration. In another approach, the LLM is prompt-engineered. A database of example tickets, classes, technical documents, and/or available building automation operation data are used. The LLM is prompted to review the database to acquire knowledge about semantics, syntax, and terms (e.g., ontology) for the building automation context.

Other types of learning context for LLM may be used. For example, reinforcement learning based on human feedback (RLHF) (e.g., proximal policy optimization) is used. As another example, instruction tuning is used based on bootstrapping from human-generated corrections. In yet another example, a mixture of experts (MoE) process is used.

Once the context is learned or without specific calibration for building automation, the LLM is used for specific tickets. Acts 1-14 may be pre-computed to generate a few-shot prompt. The context learning is performed separately from the prompt generation and/or acts to generate the prompt. In alternative approaches, the LLM is not asked to learn or review context separate from any context in the prompt to assign class.

In act 6, the LLM classifies or performs classification in response to the prompt generated in act 4. The prompt includes the information defined by the template. For example, the prompt lists possible classes and is free of any example relation between tickets and classes. In response, the LLM assigns a class.

The LLM sends back a predicted class for each prompt. In act 7, the tickets of the samples collected in act 5 and the LLM assigned or LLM generated classes are collected. Each prompt is associated to an input ticket, so the predicted class that corresponds to a prompt is the predicted class for the ticket.

This collection is a set of samples to be used for the few-shot classification in act 19. In one implementation without hybrid annotation, the set of sample tickets and corresponding LLM generated classes are provided as the set collected in act 14. In the implementation represented in FIG. 1, the set of sample tickets and corresponding LLM generated classes are further refined by hybrid annotation in act 8. In other implementation, the set is used for the few-shot classification as a pre-computation to form a collection for searching for similar examples to provide as context in the few-shot classification prompt generated for a given input ticket received in act 17.

In act 8, the processor corrects the zero-shot classifications for one or more (e.g., subset or all) of the sample tickets. The correction is by a user. The user views the ticket and the zero-shot classification. If incorrect, the user corrects the classification or indicates that the classification is wrong. The input by the user is received by the processor, which corrects the labeling or annotation for class for the sample ticket as either a different class or not the correct class. This provides a hybrid annotation.

An annotation tool is provided to one or more users to review the zero-shot classifications of the sample tickets collected in act 5. In one implementation, the annotation tool is generated as part of a user interface with the binary question of whether a predicted class is correct or incorrect for the associated ticket. All the sample tickets and their associated predicted classes are passed as inputs to this tool, and the binary question is asked to a human annotator for each ticket. The yes/no result (correct or incorrect) is a correction of the classification. The correction may not provide the correct class but is a correction of the wrong class or affirmation of the correct class. Alternatively, the binary question is followed by a request to select the correct classification, or the binary question is skipped, and the user is asked to select a classification.

In act 12, the results of the hybrid annotation are collected. The output of the hybrid annotation of act 8 is collected. This collection is a set of sample tickets with classification. The classification is the zero-shot classification or a classification chosen by a user over or to change the zero-shot classification. In one implementation, the collected set contains a sub-set of the tickets from the set collected in act 5 and their associated class for which a human annotator answered that the associated class (predicted by the zero-shot classification) was correct. The sample tickets annotated as incorrect in the correction are not included. The set is of sample tickets with the correct zero-shot classification and not the sample tickets incorrectly classified in act 6. In another implementation, all the sample tickets collected in act 5 are included. The classification is the zero-shot classification for those annotated as correct and a user selected classification for those indicated as incorrect.

The hybrid annotation in act 8 and resulting collection in act 12 may be performed as needed. Alternatively, acts 8 and 12 are performed as a pre-computation. The acts are performed prior to receiving a ticket for an issue with a building automation system in act 17.

Acts 9-11 provide for optional manual annotation of sample tickets. In act 9, a dataset of unlabeled sample tickets is collected. The samples tickets are the same or different than the sample tickets collected in act 5. The collection in act 9 is of tens, hundreds, or thousands of sample tickets. The number may depend on the human or expert resources available for manual annotation. The typical size of this dataset may be a few hundred tickets depending on resources. If resources do not permit, acts 9-11 are not provided. If not provided, the annotations combined in act 13 lack robust manual annotations, which may have a slight negative impact in performance.

In act 10, the user, using an annotation tool of the user interface, manually annotates the classes for the sample building automation tickets collected in act 9. The processor presents the annotation tool to one or more users (e.g., experts). The same or a different annotation tool used in act 8 is used.

Instead of asking if a classification is correct or for another correction, the user is asked to select the initial classification. A drop-down list or other presentation of the available classifications and descriptions may be presented for selection. The annotation tool presented on the user interface allows selecting the correct class for a ticket from the set of all classes. Alternatively, the user enters the classification or a code for the classification. The tickets collected in act 9 are passed as inputs to the annotation tool, and the user interface is presented to a human annotator for each ticket. The user or annotator enters the class for each sample ticket collected in act 9.

In act 11, the manually annotated sample tickets and corresponding classifications are collected. A set of manually annotated tickets and their annotations is formed. All the tickets collected in act 9 and their associated class provided manually in act 10 are collected.

In act 13, the processor combines the sets collected in acts 11 and 12. Act 13 may be performed by directly collecting the sample tickets and classifications resulting from acts 8 and 10, effectively combining acts 11 and 12 into act 13.

The collection includes sample tickets and corresponding classifications. The classifications are from manual annotation and/or zero-shot classification with correction (pass or selected as correct in review and/or classification changed by the user—i.e., hybrid annotation). Since this collection of samples is to be used as context for few-shot prompting an LLM, the collection may be created before the few-shot prompt is generated in act 18 or the actual ticket is received in act 17. The collection of samples is formed as a pre-computation and does not need to be repeated. The collection may be updated, such as using results from the few-shot classification in act 19 after confirmation of correctness using the annotation tool of act 8.

In acts 14 and 15, the processor partitions the set of collected samples from act 13. The samples (labelled tickets) collected in acts 14 and 15 are mutually exclusive. The partition may be random and at any ratio, such as 50, 60, or 75% collected in act 14 and 50, 40 or 25% collected in act 15. The partition may be by classification, so that the same ratio of sample tickets for each classification is collected in acts 14 and 15. The partition may be performed by the user, such as the user selecting which tickets are to be in each collection. The partition or size of this split may depend on the availability of resources and number of samples and classifications collected in act 13.

In act 14, the processor collects sample tickets and classifications from the partition to be available as context for the in-context or few shot classification of act 19. The sample tickets and classifications collected in act 14 are available for searching for classifying the actual ticket received in act 17.

In act 15, the sample tickets and classifications are collected for use in evaluation. The collection for act 15 contains the split of the dataset combined in act 13 that was not selected for collection in act 14. The sample tickets and classifications collected in act 15 are used for evaluating the performance of the ticket classification approach—e.g., evaluating few-shot classification performance (act 19) and/or evaluating zero-shot classification performance (act 6).

The partition and collecting of acts 14 and 15 may be pre-computed. The acts are performed prior to receiving the ticket in act 17. Alternatively, the partition is performed in response to receiving the ticket in act 17.

In act 17, the processor receives a building automation ticket to be classified. The ticket is for a report, issue, or help request from a building engineer or building automation technician. Rather than being a sample, the ticket is for an issue currently existing in a building automation system. The building automation ticket may have a same or different format as the sample tickets.

In act 16, the processor selects a few-shot prompt template. A standardized template is used for prompting the LLM in act 19. The processor identifies the appropriate template.

The template sets or has fields for the information to be used in the prompt. Any of various types of information may be used. For example, the prompt template includes one or more instructions to the LLM, a field or fields for the classes and descriptions, a field or fields for the ticket, and a question. The instruction and the question relate to the purpose, such as informing the LLM what it will be given as the instruction and asking the class as the question. In another example, the template defines the information to be extracted and used to generate the prompt in act 18. The few-shot prompt template takes the class definitions from act 1 and the building automation ticket received in act 17 for creation of the few-shot prompt in act 18. Other formats for the template may be used.

The few-shot prompt template repeats the information used for zero-shot classification but may have a different format. The few-shot prompt template also includes one or more (e.g., a few, such as 1-500) fields for context information not provided in the zero-shot prompt template. The fields for context information are fields for sample tickets, such as fields for title, description, and classification for sample tickets.

In act 18, the processor generates the few-shot prompt. The few-shot template is filled. Data mining, searching, look-up, or another process extracts the information to populate the template selected in act 16. By using the few-shot template, the information is reformatted as defined by the template. The processor instantiates the few-shot prompt using the few-shot prompt template.

The few-shot prompt generated in act 18 includes contextual information. The contextual information is sample tickets and corresponding classification for in-context learning. A few (e.g., 1-500) sample tickets are selected from the set collected in act 14. Few is in the LLM context, so is 1-500 but context with a greater number (e.g., 1,000) may be used. The number of few-shot samples depends on the context size of the LLM. Typically, the number of few-shot samples is less than 100.

These selected samples provide contextual information to the LLM for classification. Rather than zero-shot classification, which does not have similar examples in the prompt, few-shot or in-context classification benefits by including a few samples in the prompt.

The context examples in the few-shot prompt are selected based on similarity to the input ticket received in act 17 from the collection formed in act 14. In one implementation, semantic or other word or language similarity in the title and/or description of the issue is used to select the most similar sample tickets. Other selection methods, such as pre-selected samples or random sampling, can be also employed, depending on the requirements. The selection may have constraints, such as including at least one sample from every class.

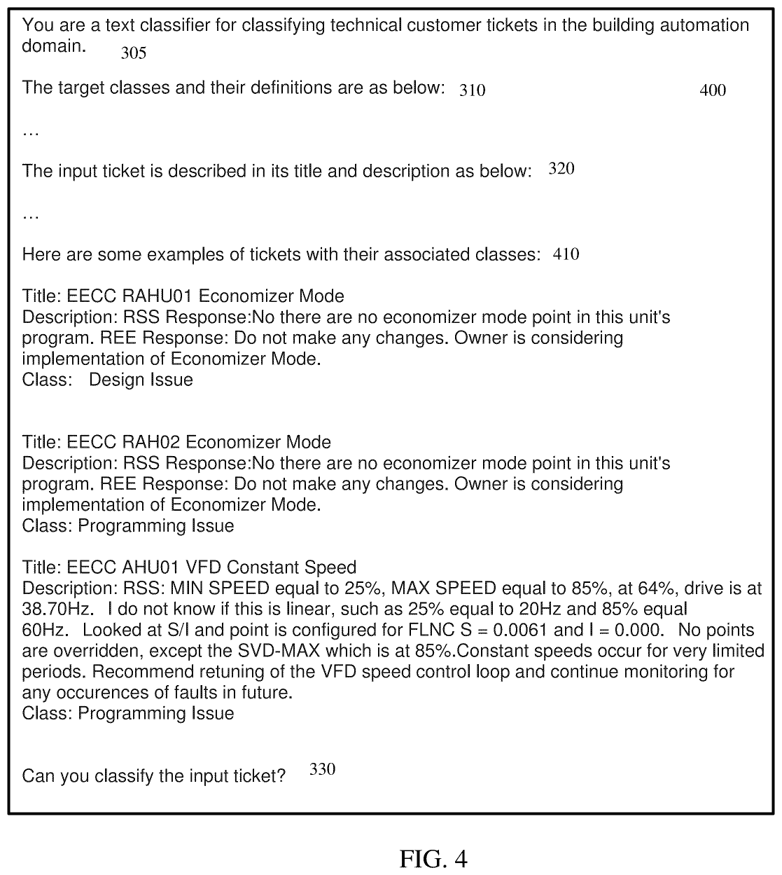

FIG. 4 shows an example few-shot prompt 400. The class definition 310 and ticket description 320 (also shown as a sample ticket in FIG. 3) are not shown for simplicity. The few-shot prompt 400 includes an instruction 305, classes and definitions 310, sample ticket information 320, context samples 410, and a question or prompt 330. Additional, different, or less information may be included. In this example, three sample tickets are selected from the set collected in act 14 based on word similarity. A fewer or greater number of contextual samples may be included in the few-shot prompt 400.

The contextual samples include the title, description, and classification. Additional, different, or fewer information may be included. The contextual samples indicate class membership for similar or selected samples. The LLM may use this information to classify using few-shot or in-context classification.

In act 19, the processor performs few-shot classification. The processor inputs the few-shot prompt generated in act 18 to the LLM. The few-shot prompt generated in act 18 is passed to the classifier (LLM). The LLM, as implemented by the processor, performs few-shot classification for the building automation ticket received in act 17. The few-shot classification uses information selected from the sample building automation tickets collected in act 14. For example, the samples include the sample building automation tickets and the zero-shot classifications after review in act 8 (i.e., user confirmed correct classification).

The LLM sends back a predicted class for the ticket received in act 17 in response to the few-shot prompt. As the prompt is associated to the input ticket, the predicted class that corresponds to the prompt is the predicted class for the input ticket received in act 17.

The few-shot classification is performed in response to input to the LLM of the few-shot prompt, including the context examples as well as the class definitions (possible classes). The context examples provide verified zero-shot classification (e.g., hybrid annotation) or manually entered classification as examples that are similar to the ticket to be classified.

In act 20, the processor transfers the building automation ticket based on the classification. The ticket and class may be transferred. The transfer is to a queue, in-box, memory, group (e.g., team or department), or assigned expert appropriate for the class. For example, a ticket classified as a programming issue is sent to a programmer or programmers for building automation. As another example, a ticket classified as a duct issue is sent to an engineer(s) or technician(s) for duct work in building automation.

The transfer routes the ticket to a source for providing a solution. Once the solution is determined, the building automation system is altered to implement the solution. By efficient and scalable ticket classification in a diverse and complex building automation field, the LLM classification provides for more rapid and accurate alteration of the operation of the building automation system. Tickets are less likely to be misdirected, and the classification does not provide as much delay as a human classifier would. The computer operates better relying on the LLM rather than human.

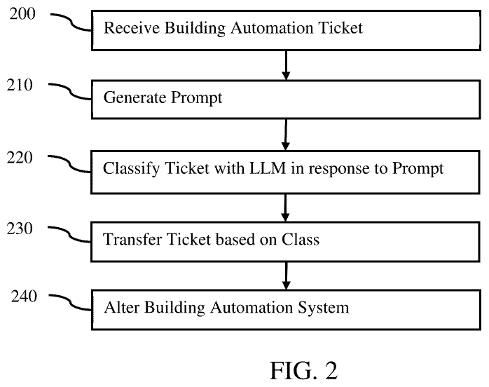

FIG. 2 is a flow chart diagram of another implementation of the method for ticket classification for a building automation system. FIG. 2 is directed to a process for classification using LLM timed around the receipt of the actual building automation ticket to be classified. LLM or LLM with few-shot classification, zero-shot classification, hybrid annotation, manual annotation, and/or partitioning of samples is used for classification. Given the timing, any hybrid annotation, manual annotation, partitioning, and/or zero-shot classification is reflected in the samples available for selection to be used as context in the few-shot classification. Alternatively, the LLM performs zero-shot classification.

Additional, different, or fewer acts may be provided. For example, act 240 is not performed. As another example, act 230 is not performed, such as where the classification is instead used to generate the alteration without transfer (e.g., used to look up a solution by class). In another example, an act for evaluating performance of the classification of act 220 may be provided. The acts are performed in the order shown (top to bottom or numerical) or a different order.

The method is performed by the system of FIG. 5 or another system. In one implementation, an interface or processor receives the ticket in act 200 and transfers the class in act 230. The processor generates the prompt in act 210. The same or a different processor classifies in act 220. The processor or engineer alters the building automation system based on the ticket, such as altering programming or operation of a duct, valve, heater, cooler, panel, controller, sensor, or other building automation component.

In act 200, a processor receives a building automation ticket for an issue in the building automation system. The building automation ticket is received by communications over a computer network. Alternatively, or additionally, a person enters the ticket into a computer.

The building automation ticket has any format with any information, such as discussed above for the actual building automation ticket received in act 17 or the sample tickets collected in act 5 or 9. In one implementation, the building automation ticket to be classified includes a subject or title and a description.

In act 210, the processor generates a prompt. The prompt to be generated is for the LLM. The prompt may be generated by filling-in a template. Alternatively, the prompt is generated by following a workflow or function. The prompt is generated in alphanumeric text or audio. A sentence format with or without structure (e.g., fields) may be used.

The prompt includes the building automation ticket and a request for classification of the building automation ticket. An instruction or explanation may be included. A list of classes, with or without class descriptions, may be provided.

In one example, the prompt is a zero-shot classification prompt, such as shown in FIG. 3. In another example, the prompt is a few-shot classification prompt, such as shown in FIG. 4. The prompt is generated to include at least one (e.g., 1-500) example tickets and classes for the example tickets. The prompt also includes a statement that the example tickets and corresponding classes are provided as examples.

In one approach, the class for the example ticket was previously generated with zero-shot classification by the same or a different LLM. The class for the example may have been generated as an annotation or labeling based, at least in part, by expert input. The zero-shot classification may have been reviewed or corrected (e.g., identified as correct) as a hybrid annotation. User correction by selecting of correct, removal of incorrect, and/or by changing the class is provided by hybrid annotation. In another approach, the class for the example ticket was previously generated as a manual annotation by an expert (user). Hybrid and manual annotation may be combined. For example, the prompt is generated to include multiple example tickets and corresponding classes. One or more example classes are from zero-shot classification by the LLM with or without review or correction by a user, and one or more examples classes are from manual labeling or initial class assignment by a user.

For generating a few-shot prompt, the example tickets and classes are selected from a previously created database. Similarity of the example ticket to the received building automation ticket is used to select the example. Other criteria may be used, such as random selection.

The database may be a partition of available examples. The partition may reserve some examples and corresponding classes for evaluation. The remaining examples and classes are available for selection for in-context classification using a few-shot prompt.

In act 220, a processor classifies the building automation ticket. An LLM, implemented or instantiated by the processor, classifies the ticket in response to input of the prompt to the LLM. The LLM was trained on a corpus of knowledge. In one implementation, the LLM used was trained on a corpus that includes technical information, such as building automation information. In other implementations, the LLM was not trained on building automation information and/or technical information.

In act 230, the processor or interface transfers the building automation ticket based on the classification. The classification indicates to where the ticket should be sent. For example, the classification is used to identify the technical team to which the ticket should be sent. The ticket is then sent to that technical team.

In act 240, a processor or technician alters the building automation system. A solution is found to address the issue identified in the transferred ticket. The technical team implements the solution. For example, a physical change of a component is instructed, and then performed. As another example, a programming change, such as a set point or process change, is the solution. A controller is altered to implement the programming change, such as altering the controller by a processor sending an update.

FIG. 5 shows a building automation ticket classification system. The building automation ticket classification system may form a building automation system or include a building automation system. LLM is used to classify help tickets with respect to a building automation system 570.

The building automation ticket classification system includes the interface or interfaces 500, processor 510, memory 520, user input 530, and display 540. The display 540, processor 510, user input 530, and/or memory 520 may be part of a computer, server, workstation, or another system for handling ticket classification.

The building automation ticket classification system may further include a server 550 connected to the interfaces 500 through a computer network. The server 550 hosts the LLM 552. In other implementations, the LLM 552 is hosted locally to the processor 510, such as where the processor 510 is part of a server or where the LLM 552 is implemented on a computer at a manufacturer or manager of the building automation system 570. In other implementations, the processor 510 is part of the building automation system 570, whether local or remote from the building. The LLM 552 is hosted by the building automation system.

Additional, different, or fewer components may be provided. For example, a computer network is included for remote application of the LLM based on locally entered input and output results. As another example, additional building automation systems 570 are provided, such as where the processor 510 and/or server 550 are used for a service provided to different building automation systems.

The building automation system 570 includes heating ventilation air conditioning (HVAC), fire safety, security, and/or other automated arrangements for operating a building. The building automation system 570 may be for one building, one floor, multiple floors of a building, multiple buildings, a facility, and/or a complex. The building automation system 570 may include panels, controllers, sensors, user inputs, actuators, alarms, ducts, heaters, air conditioners, filters, boilers, heat exchangers, supervisor computers, and/or other components.

One or more engineers or technicians may operate or control operation of the building automation system 570. Issues with the operation may occur. The engineers or technicians may request help from a manufacturer and/or service by generating a ticket. The ticket is communicated via a computer network to the manufacturer or service. The manufacturer or service may include different technical teams 560 to address tickets. The ticket is to be classified in order to route the ticket to the expert technical team 560 likely to provide a solution to the issue.

The interface 500 is shown as one interface, but multiple interfaces may be provided. The interface 500 is a modem, computer network interface, ethernet interface, Wi-Fi, Bluetooth, and/or other computer networking interface for receiving and/or transmitting communications.

The interface 500 is configured by a specification or standard design, controller, and/or by the processor 510. The interface 500 is configured to receive the building automation ticket. The ticket includes a title (e.g., subject), description, and/or other information. For example, the ticket may include logging or event information, such as error codes and/or readings over time.

The processor 510 is a control processor, general processor, digital signal processor, graphics processing unit, application specific integrated circuit, field programmable gate array, artificial intelligence processor or accelerator, digital circuit, analog circuit, combinations thereof, or another now known or later developed device for implementing the LLM 552 and/or processing building automation tickets. The processor 510 is a single device, a plurality of devices, or a network. For more than one device, parallel or sequential division of processing may be used. Different devices making up the processor 510 may perform different functions or the same function in parallel. For example, the server 550 may be part of the processor 510 where the server 550 hosts the LLM 552 and the processor 510 is part of a computer or workstation for generating the prompt and processing a ticket based on class. The processor 510 operates pursuant to stored instructions, hardware, and/or firmware to perform various acts described herein.

The processor 510 is configured to pre-compute prompt information. For example, the processor 510 performs or is used for acts 1-15 of FIG. 1. Alternatively, another processor performs the pre-computation for generating the prompt, so the memory 520 stores the collection of example tickets and respective classes. The processor 510, server 550, and/or another processor may perform any calibration or training of the LLM 552 for operating in the building automation context.

For processing a ticket received from the building automation system 570 or someone responsible for the operation of the building automation system 570, the processor 510 is configured to generate a prompt. The ticket, class definitions, sample tickets and respective classes, templates, instructions, questions, and/or other prompt information are stored in the memory 520 and/or another memory. The information for the prompt is extracted, searched, data mined, or otherwise acquired and used to generate the prompt.

The prompt is generated as an in-context (e.g., few-shot) prompt, so includes the building automation ticket and one or more similar sample building automation tickets with respective one or more sample classes. The sample classes of the similar sample building automation tickets may be based on a zero-shot classification by the same LLM 552 or a different LLM. The sample classes based on the zero-shot classification may have been verified as accurate using hybrid annotation, such as through the processor 510, the user input 530, and/or the display 540 being a user interface for annotation tool. Another computer may have been used for the hybrid annotation tool. The sample classes may alternatively, or additionally, be based on manual annotation by an expert. The processor 510, the user input 530, and/or the display 540 may have provided a user interface for an annotation tool for manual classification. Another computer may have been used for the manual annotation tool.

The processor 510 selects the sample building automation tickets from a database, such as the memory 520 or another (e.g., remote) memory. The database of sample building automation tickets and classes may be a partition of a collection of sample tickets based, at least in part on zero-shot classification. The other partition may be used for evaluation of the LLM-based classification.

The server 550 is a computer, workstation, graphics processing unit, tensor processor, artificial intelligence processor, and/or server card. The server 550 is configured by hardware, firmware, and/or software to implement the LLM 552. Alternatively, the processor 510 implements the LLM 552.

The processor 510 or server 550 is configured to apply the LLM 552 for classifying the building automation ticket. The processor 510 or server 550 receives the prompt, such as the few-shot prompt generated by the processor 510, and provides the prompt to the LLM 552. The processor 510 or server 550 applies the LLM 552. The LLM 552 generates a classification (e.g., a label or annotation identifying the building automation class to which the ticket belongs).

The processor 510 is configured to receive the class from the server 550 via the interface 500 or receive the class from application of the LLM 552. The processor 510 is configured to distribute or route (e.g., transfer) the ticket based on the class. A table of different classes and the corresponding technical team 560, such as a group of building automation engineers or an individual, is used to look-up the destination. The interface 500 is used to communicate the ticket to the identified technical team 560.

The memory 520 is configured by formatting and/or the processor 510 to store information for classification of the building automation ticket. For example, the memory 520 stores the ticket, LLM-generated class 522 for the ticket, prompt, template, class definitions, sample building automation tickets and respective classes, and/or other information used in ticket classification. The memory 520 may store the LLM 552 for ticket classification.

The memory 520 is an external storage device, RAM, ROM, database, and/or a local memory (e.g., solid state drive or hard drive). The same or different non-transitory computer readable media may be used for the instructions and other data. The memory 520 may store instructions for operating the processor 510 and/or the server 550. The memory 520 may be implemented using a database management system (DBMS) and/or be a hard disk, RAM, or removable media. Alternatively, the memory 520 is internal to the processor 510 (e.g., cache). The memory 520 is formed from one device or a collection of devices, such as different memories storing different types of data.

The instructions for implementing the training (e.g., prompt engineering and/or calibration), application process (i.e., building automation ticket classification), the methods, and/or the techniques discussed herein by the processor 510 are provided on non-transitory computer-readable storage media or memories, such as a cache, buffer, RAM, removable media, hard drive or other computer readable storage media (e.g., the memory 520). Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the way the present embodiments are programmed.

The user input 530 is a keyboard, buttons, sliders, dials, trackball, mouse, touch pad, touch screen, microphone, and/or another device for user interaction with the processor 510 and/or building automation ticket classification system. The user input 530 is part of a graphics user interface for receiving user input, such as the ticket and/or annotations (hybrid or manual). The user input 530 may be configured by the processor 510 and/or hardware to receive annotations or confirm proper classification. For example, the user input 530 is configured by the user interface to receive an annotation correcting the sample class (e.g., confirming correct class, indicating incorrect class, and/or changing the class). As another example, the user input 530 is configured by the user interface to receive a manual annotation initially assigning a class to a sample building automation ticket. The user input 530 may be used to confirm, change, and/or input for classification of the building automation ticket.

The display 540 is a CRT, LCD, projector, plasma, printer, tablet, smart phone, or another now known or later developed display device for displaying the prompt, ticket, class, and/or other information. The display 540 is configured by loading an image to a display buffer or plane, which image is then displayed on a screen. Other configuration may be provided, such as configuring for display by printing. The display 540 may be configured to display the solution from the technical team 560 to the issue of the ticket, a ticket status, ticket class, and/or other information.

The solution is routed to the building automation system 570. The solution changes programming and/or hardware of one or more components of the building automation system 570. By using LLM for classification, the solution may be provided more rapidly, and the classification leading to the solution may be more accurate despite the diverse issues of building automation systems and/or number of building automation systems.

FIG. 6 shows an example transformer. The LLM is formed from one or more transformers. In FIG. 6, a schematic representation of a transformer model TM is shown. The transformer model TM is configured to process a prompt as input INPT and return a class as output OUT. The transformer architecture follows an encoder-decoder structure formed from an encoder ENC 600 and a decoder DEC 620. In brief, the task of the encoder ENC 600 is to map an input INPT to a sequence of continuous representations R 610, which is then fed into a decoder DEC 620. The decoder DEC 620 receives the representations R 610 to generate an out-put OUT. The decoder output OUTR at a previous iteration may be input to generate the out-put OUT.

The encoder ENC 600 is generally configured to transform individual data items of the input INPT into a numerical representation R 610. According to some examples, the numerical representation R 610 may take the form of a numerical vector for each data item of the input INPT. The representation R encodes how relevant a particular data item of the input INPT is with regard to other data items in the input INPT. To provide the numerical representation R 610, the encoder ENC 600 may include a plurality of blocks. A first block EB may be configured as an embedding block EB configured to bring the data items into a machine-readable form, the so-called embeddings, while preserving certain relations of the data items such as positional relations. In particular, the embeddings may be numerical vectors. The embeddings are fed into a second block SAB which may be designated as a self-attention block SAB. The self-attention block SAB implements a self-attention mechanism configured to determine how relevant a particular data item of the input INPT is with regard to other data items in the input INPT and modify the embeddings based on this information so as to generate attention vectors. According to some examples, the self-attention block SAB may be realized as neural network with one or more hidden layers. Said neural network may be trained to determine multiple attention vectors by data item and integrate these into one resulting attention vector. With regard to the latter, the self-attention block SAB may be configured to implement an additive or dot-product-based combination of individual attention vectors. The dimension of the attention vectors generated reflects how many data items are being compared in the self-attention block SAB. If, for instance, the self-attention block SAB is configured to compare 768 data items, the self-attention vector may have a dimension of 768 entries. The attention vectors are then fed into an adaptation block AB which is configured to map the attention vectors to a form which is suited for further processing (either by another self-attention block or the decoder or any other downstream processing).

The decoder DEC 620 may generally be configured to map the representation R 610 onto a desired output OUT. The decoder DEC 620 is configured to compute the output OUT based on the representations R 610 provided by the encoder ENC 600 with or without an output OUTR of a previous iteration. Like the encoder ENC 600, the decoder DEC 620 relies on a self-attention mechanism. Specifically, the decoder DEC 620 may include a plurality of blocks. Similar to the encoder ENC 600, a first block EB may be configured as an embedding block EB translating the previous output OUTR into embeddings. The embeddings are input to a self-attention block SAB configured to provide an attention vector of the previous output OUTR based on its embeddings. The attention vectors of the previous output OUTR are input into an encoder-decoder self-attention block ED-SAB together with the representations R 610 as provided by the encoder ENC 600. The encoder-decoder self-attention block ED-SAB is configured to map the representation to the attention vectors of the previous output OUTR so as to regressively improve the previous output OUTR. The output of the encoder-decoder self-attention block ED-SAB may be seen as attention vectors for data items in the input INPT and the vector space of the desired output OUT based on the previous output OUTR. These attention vectors are then fed into an adaptation block AB configured to map the attention vectors to a form suited for further processing (either by another self-attention block or by way of the generation of the final output).

The designation of the distinct blocks EB, SAB, ED_SAB, AB and the number of blocks shown in FIG. 7 is to be construed by way of example and not as a limitation. Specifically, individual blocks EB, SAB, AB may be integrated to form one single block. In particular, all blocks may respectively be a neural network each with a plurality of layers. Moreover, there may be a plurality of stacks of self-attention blocks SAB and adaptation blocks AB in the encoder ENC 600, wherein the last adaptation block provides the final numerical representation R 610. Likewise, there may be a plurality of stacks of encoder-decoder self-attention blocks ED-SAB and adaptation blocks AB in the decoder DEC 620, wherein the last adaptation block AB provides the final output OUT. According to some examples, the decoder structure shown in FIG. 6 may be replaced by a final adaptation block also referred to as “interpreter” configured to directly map the representation of the encoder on one or more learned outputs OUT which are human understandable.

In some instances, the encoders and/or decoders are composed of several corresponding encoding layers and decoding layers, respectively. Within each encoding and decoding layer preferably there is an attention mechanism. The attention mechanism, sometimes denoted as self-attention, relates data items (such as words or pixels) within a series of data items to other data items within said series. The self-attention mechanism for instance allows the model to examine a group of words within a sentence and determine the relative importance of other groups of words within that sentence for the group of words being examined. The encoder, in particular, may be configured to transform the input text into a numerical representation. The numerical representation may be a vector per input token (e.g., per word). The encoder may be configured to implement an attention mechanism so that each vector of a token is affected by the other tokens in the input. In particular, the encoder may be configured such that the representations R 610 resolve the desired output of the transformer network TM.

The decoder, in particular, may be configured to transform an input into a sequence of output tokens. In particular, the decoder may be configured to implement a masked self-attention mechanism so that each vector of a token is affected only by the other tokens to one side of a sequence. Further, the decoder may be auto-regressive meaning in that intermediate results are fed back. According to some examples, the input of the decoder is based on the output of the encoder or equivalent to the output of the encoder. Further, the transformer network may include a classification module configured to map the output of the encoder or decoder to a set of learned outputs.

Training of a transformer model according to some examples may happen in two stages, a pretraining and a fine-tuning stage. In the pretraining stage, a transformer model may be trained on a large corpus of data to learn the underlying semantics of the problem. Such pre-trained transformer models are available for different languages. For certain applications described herein, the fine-tuning may include further training the transformer network with building automation or technical texts. The transformer model according to some examples may learn typical relations and synonyms of building automation expressions.

An advantage of transformer networks is that, due to the attention mechanism, transformer networks can efficiently deal with long-range dependencies in input data. Further, encoders used in transformer networks are capable of processing data in parallel, which saves computing resources in inference. Moreover, decoders of transformer networks, due the auto-regression, are able to iteratively generate a sequence of output tokens with great confidence.

Listed below are various Illustrative Embodiments. The Illustrative Embodiments summarize different combinations of aspects. Other combinations of any of the aspects with any other one or more of the aspects may be provided. Aspects from one type (e.g., method or system) may be used in another type (system or method).

Illustrative Embodiment 1. A method for ticket classification in a building automation system, the method comprising: receiving a building automation ticket for an issue in the building automation system; generating a prompt including the building automation ticket, the prompt including a request for classification of the building automation ticket; classifying the building automation ticket by a large language model in response to input of the prompt to the large language model; and transferring the building automation ticket based on the classification.

Illustrative Embodiment 2. The method of Illustrative Embodiment 1 wherein generating the prompt comprises generating the prompt with at least one example ticket and class for the example ticket.

Illustrative Embodiment 3. The method of Illustrative Embodiment 2 wherein generating the prompt comprises generating the prompt with the class for the example ticket having been generated with zero-shot classification.

Illustrative Embodiment 4. The method of Illustrative Embodiment 3 wherein generating the prompt comprises generating the prompt where the class for the example ticket was generated with annotation of the class.

Illustrative Embodiment 5. The method of Illustrative Embodiment 4 wherein generating the prompt comprises generating the prompt where the annotation comprises a hybrid annotation that was generated in response to a user correction of the zero-shot classification.

Illustrative Embodiment 6. The method of any of Illustrative Embodiments 2-5 wherein generating the prompt comprises generating the prompt where the class for the example ticket was generated as a manual annotation from a user.

Illustrative Embodiment 7. The method of any of Illustrative Embodiments 2-6 wherein the at least one example ticket and class comprises at least two example tickets and corresponding classes, one of the at least two corresponding classes being from a zero-shot classification by the large language model and another of the at least two corresponding classes being from a manual class assignment by a user.

Illustrative Embodiment 8. The method of any of Illustrative Embodiments 2-7 wherein generating the prompt comprises selecting the at least one example ticket and class from a database, the selecting uses a similarity of the building automation ticket to the at least one example ticket and class.

Illustrative Embodiment 9. The method of Illustrative Embodiment 8 wherein the database comprises a partition of a set of the example building automation tickets and annotated classes.

Illustrative Embodiment 10. The method of any of Illustrative Embodiments 1-9 wherein classifying comprises classifying by the large language model, the large language model having been trained on a dataset including building automation information.

Illustrative Embodiment 11. The method of any of Illustrative Embodiments 1-10 wherein transferring comprises selecting between technical teams based on the classification.

Illustrative Embodiment 12. The method of Illustrative Embodiment 11 further comprising altering the building automation system by a technician with a solution resulting from the transferring to one of the technical teams.

Illustrative Embodiment 13. A method for ticket classification in a building automation system, the method comprising: performing zero-shot classification for each of a first set of sample building automation tickets, the zero-shot classification performed by a large language model; correcting the zero-shot classification, the correcting being by a user; receiving a first building automation ticket for the building automation system; performing, by the large language model, few-shot classification for the first building automation ticket, the few-shot classification using information selected from a second set of sample building automation tickets, the second set comprising at least some of the sample building automation tickets of the first set and the zero-shot classifications from the first set after the correcting; and transferring the building automation ticket based on the classification.

Illustrative Embodiment 14. The method of Illustrative Embodiment 13 wherein performing the zero-shot classification comprises performing in response to a first prompt listing possible classes and free of any example relation between tickets and classes, wherein performing the zero-shot classification and the correcting comprises forming the first set for use in the few-shot classification as a pre-computation, and wherein performing the few shot classification comprises performing in response to a second prompt listing the possible classes and with the information comprising one or more of the sample building automation tickets and zero-shot classifications corresponding to the one or more sample building automation tickets, the information selected from the second set based on a similarity to the first building automation ticket.

Illustrative Embodiment 15. The method of any of Illustrative Embodiments 13-14 further comprising manually annotating classes for sample building automation tickets of a third set, wherein performing the few-shot classification comprises performing with the information selected from the second set including the sample building automation tickets of the first and third sets.

Illustrative Embodiment 16. The method of any of Illustrative Embodiments 13-15 wherein performing the few-shot classification comprises performing where the second set for the selection comprises a partition of the first set.

Illustrative Embodiment 17. A building automation ticket classification system comprising: a first interface configured to receive a first building automation ticket comprising a title and description of an issue in a building automation component; a processor configured to generate a prompt, the prompt including the first building automation ticket, a similar sample building automation ticket with a sample class based on a zero-shot classification by a large language model of the similar sample building automation ticket; a second interface configured to receive a first class for the first building automation ticket, the first class generated by the large language model in response to input of the prompt; and a memory configured to store the first class.

Illustrative Embodiment 18. The building automation ticket classification system of Illustrative Embodiments 17 further comprising: a user input configured to receive an annotation correcting the sample class.

Illustrative Embodiment 19. The building automation ticket classification system of Illustrative Embodiment 18 wherein the user input is configured to receive another annotation assigning a second class to a second sample building automation ticket, the processor configured to generate the prompt as including the second sample building automation ticket and the second class.

Illustrative Embodiments 20. The building automation ticket classification system of any of Illustrative Embodiments 17-19 wherein the processor is configured to select the similar sample building automation ticket from a database, the database comprising a partition of samples based on the zero-shot classification.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for ticket classification in a building automation system, the method comprising:
receiving a building automation ticket for an issue in the building automation system;
generating a prompt including the building automation ticket, the prompt including a request for classification of the building automation ticket;
classifying the building automation ticket by a large language model in response to input of the prompt to the large language model; and
transferring the building automation ticket based on the classification.

2. The method of claim 1 wherein generating the prompt comprises generating the prompt with at least one example ticket and class for the example ticket.

3. The method of claim 2 wherein generating the prompt comprises generating the prompt with the class for the example ticket having been generated with zero-shot classification.

4. The method of claim 3 wherein generating the prompt comprises generating the prompt where the class for the example ticket was generated with annotation of the class.

5. The method of claim 4 wherein generating the prompt comprises generating the prompt where the annotation comprises a hybrid annotation that was generated in response to a user correction of the zero-shot classification.

6. The method of claim 2 wherein generating the prompt comprises generating the prompt where the class for the example ticket was generated as a manual annotation from a user.

7. The method of claim 2 wherein the at least one example ticket and class comprises at least two example tickets and corresponding classes, one of the at least two corresponding classes being from a zero-shot classification by the large language model and another of the at least two corresponding classes being from a manual class assignment by a user.

8. The method of claim 2 wherein generating the prompt comprises selecting the at least one example ticket and class from a database, the selecting uses a similarity of the building automation ticket to the at least one example ticket and class.

9. The method of claim 8 wherein the database comprises a partition of a set of the example tickets and annotated classes.

10. The method of claim 1 wherein classifying comprises classifying by the large language model, the large language model having been trained on a dataset including building automation information.

11. The method of claim 1 wherein transferring comprises selecting between technical teams based on the classification.

12. The method of claim 11 further comprising altering the building automation system by a technician with a solution resulting from the transferring to one of the technical teams.

13. A method for ticket classification in a building automation system, the method comprising:
performing zero-shot classification for each of a first set of sample building automation tickets, the zero-shot classification performed by a large language model;
reviewing the zero-shot classification, the reviewing being by a user;
receiving a first building automation ticket for the building automation system;
performing, by the large language model, few-shot classification for the first building automation ticket, the few-shot classification using information selected from a second set of sample building automation tickets, the second set comprising at least some of the sample building automation tickets of the first set and the zero-shot classifications from the first set after the reviewing; and
transferring the building automation ticket based on the classification.

14. The method of claim 13 wherein performing the zero-shot classification comprises performing in response to a first prompt listing possible classes and free of any example relation between tickets and classes, wherein performing the zero-shot classification and the reviewing comprises forming the first set for use in the few-shot classification as a pre-computation, and wherein performing the few shot classification comprises performing in response to a second prompt listing the possible classes and with the information comprising one or more of the sample building automation tickets and zero-shot classifications corresponding to the one or more sample building automation tickets, the information selected from the second set based on a similarity to the first building automation ticket.

15. The method of claim 13 further comprising manually annotating classes for sample building automation tickets of a third set, wherein performing the few-shot classification comprises performing with the information selected from the second set including the sample building automation tickets of the first and third sets.

16. The method of claim 13 wherein performing the few-shot classification comprises performing where the second set for the selection comprises a partition of the first set.

17. A building automation ticket classification system comprising:
a first interface configured to receive a first building automation ticket comprising a title and description of an issue in a building automation component;
a processor configured to generate a prompt, the prompt including the first building automation ticket, a similar sample building automation ticket with a sample class based on a zero-shot classification by a large language model of the similar sample building automation ticket;
a second interface configured to receive a first class for the first building automation ticket, the first class generated by the large language model in response to input of the prompt; and
a memory configured to store the first class.

18. The building automation ticket classification system of claim 17 further comprising:
a user input configured to receive an annotation correcting the sample class.

19. The building automation ticket classification system of claim 18 wherein the user input is configured to receive another annotation assigning a second class to a second sample building automation ticket, the processor configured to generate the prompt as including the second sample building automation ticket and the second class.

20. The building automation ticket classification system of claim 17 wherein the processor is configured to select the similar sample building automation ticket from a database, the database comprising a partition of samples based on the zero-shot classification.
